(19) United States
(12) Patent Application Publication
(10) Pub. No.: US 2013/0062317 A1
(43) Pub. Date: Mar. 14, 2013

(54) INSTALLATION SWITCHING DEVICE

(71) Applicant: ABB AG, Mannheim (DE)

(72) Inventors: Erwin MUDERS, Heidelberg (DE); Manfred Hofmann, Eberbach (DE); Rainer Ludovici, Eppelheim (DE); Roland Ritz, Dielheim (DE); Heiko Stolz, Mannheim (DE); Klaus-Peter Eppe, Waldbrunn (DE); Ralf Wieland, Waldbrunn (DE); Joachim Majewski, Dossenheim (DE); Wolfgang Pump, Ehrenfriedersdorf (DE)

(73) Assignee: ABB AG, Mannheim (DE)

(21) Appl. No.: 13/674,423

(22) Filed: Nov. 12, 2012

Related U.S. Application Data
(63) Continuation of application No. PCT/EP2011/002340, filed on May 11, 2011.

(30) Foreign Application Priority Data
May 12, 2010 (DE) 10 2010 020 345.9

(51) Int. Cl. H01H 33/08; H01H 33/20

(52) U.S. Cl. CPC H01H 33/08; H01H 33/20
USPC 218/148; 218/157

(57) ABSTRACT

An installation switching device includes a cutout, which is designed on a fastening side, for fastening the installation switching device to a mounting rail, a vent opening, which is disposed on the fastening side, for discharging waste gases from an arc-quenching device, and a quick fastening device which is disposed on the fastening side. The quick fastening device includes a slide, which carries a movable projection and encloses the housing at the broad sides and which can be acted on by means of a spring toward the inner space of the recess.

### RELATED APPLICATIONS

This application claims priority as a continuation application under 35 U.S.C. §120 to PCT/EP2011/002340, which was filed as an International Application on May 11, 2011 designating the U.S., and which claims priority to German Application 10 201 020 345.9 filed in Germany on May 12, 2010. The entire contents of these applications are hereby incorporated by reference in their entireties.

### FIELD

The present disclosure relates to an installation switching device, such as a selective circuit breaker, for example.

### BACKGROUND INFORMATION

An installation switching device may include a housing having a fastening side, a front and a rear front-panel side and broad sides and front and rear narrow sides connecting the fastening side and the front-panel side. The installation switching device may also include a main current path, which runs between an input and an output terminal and contains a main contact point provided with an arc-quenching chamber, an impact armature system bringing the main contact point into the open position, and a main thermostatic bimetallic strip, which acts on a switching mechanism with a latching point, with the result that the contact point remains permanently open. In addition, the installation switching device may include a secondary current path, in which a current-limiting resistor and a selective thermostatic bimetallic strip, which likewise acts on the switching mechanism, as well as an isolating contact point which can be opened by the switching mechanism are arranged. The installation switching device may also include a handle, with which the main contact point can be opened and closed via the switching mechanism. The secondary current path is connected in parallel with the series circuit including the first bimetallic strip with the main contact point. The main contact point is in the form of a single contact point with a fixed and a movable contact piece. At least a first exhaust air opening for discharging exhaust gases from the arc-quenching device is fitted on a narrow side next to the connection terminal.

When the main contact point has been brought into the open position, in the case of an installation switching device of the aforementioned generic type, the main contact point can be held fixedly in the open position with the aid of a short-circuiting ring in the armature of the impact armature system up to the end of the disconnection operation. Such a short-circuiting ring is shown and described in DE 10 2006 024 249 A1, for example.

An installation switching device of the generic type is known, for example, from DE 10 2008 017 472 A1. The device described therein is intended to be fitted on busbars. If it is intended to be fitted on a top-hat mounting rail, it should be fastened to a corresponding adapter. Thus, the space requirement in the distribution box is increased. The external dimensions of devices for top-hat rail fitting are established by various standards or other specifications set forth by national authorities and should not be exceeded. In particular, when switching high current intensities, the restriction in terms of size which thus needs to be taken into consideration does hinder.

### SUMMARY

An exemplary embodiment of the present disclosure provides an installation switching device which includes a housing including a fastening side, a front and a rear front-panel side, broad sides and front and rear narrow sides connecting the fastening side and the front-panel side. The exemplary installation switching device also includes a main current path, which runs between an input terminal and an output terminal and contains a main contact point provided with an arc-quenching chamber. In addition, the exemplary installation switching device includes an impact armature system bringing the main contact point into the open position, and a main thermostatic bimetallic strip, which acts on a switching mechanism with a latching point, such that the contact point remains permanently open. The exemplary installation switching device also includes a secondary current path having arranged therein a current-limiting resistor and a selective thermostatic bimetallic strip, which likewise acts on the switching mechanism, and an isolating contact point which is configured to be opened by the switching mechanism. In addition, the exemplary installation switching device includes a handle, with which the main contact point is configured to be opened and closed via the switching mechanism. The secondary current path is connected in parallel with a series circuit including the first bimetallic strip with the main contact point. The main contact point is in the form of a single contact point with a fixed and a movable contact piece. At least a first exhaust air opening for discharging exhaust gases from the arc-quenching device is fitted on a narrow side next to the connection terminal. The exemplary installation switching device also includes a cutout formed on the fastening side and being configured to fasten the installation switching device on a top-hat mounting rail. In addition, the exemplary installation switching device includes a second exhaust air opening fitted on the fastening side and being configured to discharge exhaust gases from the arc-quenching device. The exemplary installation switching device also includes a quick-action fastening apparatus fitted on the fastening side. The quick-action fastening apparatus includes a slide which is configured to bear a movable lug, surrounds the housing on its broad sides, and is configured to be acted on by means of a spring in the direction towards the interior of the cutout.

### BRIEF DESCRIPTION OF THE DRAWINGS

Additional refinements, advantages and features of the present disclosure are described in more detail below with reference to exemplary embodiments illustrated in the drawings, in which:

FIG. 1 shows a wiring diagram of an installation switching device according to an exemplary embodiment of the present disclosure;

FIG. 2 shows, schematically, an installation switching device according to an exemplary embodiment of the present disclosure, with the wiring diagram arranged in the interior of the housing;

FIG. 3 shows a schematic external view of an installation switching device according to the disclosure;

FIG. 4 shows, schematically, a plan view into an open installation switching device as shown in FIG. 3;

FIG. 5 shows, schematically, a partial sectional view of an open installation switching device from the front-panel side, according to an exemplary embodiment of the present disclosure;

FIG. 6 shows a perspective view of an installation switching device from the narrow side, according to an exemplary embodiment of the present disclosure;

FIG. 7 shows a perspective partial view into the exhaust air region of an installation switching device according to an exemplary embodiment of the present disclosure with the upper broad side removed;

FIG. 8 shows a partial view from the lower broad side of the exhaust air region of the installation switching device according to an exemplary embodiment of the present disclosure;

FIG. 9 shows a perspective view of a slide for use with a device according to an exemplary embodiment of the present disclosure;

FIG. 10 shows a perspective plan view of the slide shown in FIG. 9, from the fastening side, according to an exemplary embodiment of the present disclosure;

FIG. 11 shows a view as the slide shown in FIG. 9 is inserted straight into the fitting slots, according to an exemplary embodiment of the present disclosure;

FIG. 12 shows a view of the fastening side in the region of the broad sides of an installation switching device positioned on a top-hat mounting rail and latched to a slide as shown in FIG. 9, according to an exemplary embodiment of the present disclosure;

FIG. 13 shows a plan view as shown in FIG. 12 of the fastening side, according to an exemplary embodiment of the present disclosure; and

FIG. 14 shows a perspective view of the slide, which is located in its withdrawal position, according to an exemplary embodiment of the present disclosure.

### DETAILED DESCRIPTION

Exemplary embodiments of the present disclosure provide an installation switching device which can be fastened directly on a top-hat mounting rail and which is configured for switching even high current intensities while having a compact design with small external dimensions.

An exemplary embodiment of the present disclosure provides an installation switching device which includes a housing including a fastening side, a front and a rear front-panel side, broad sides and front and rear narrow sides connecting the fastening side and the front-panel side. The exemplary installation switching device also includes a main current path, which runs between an input terminal and an output terminal and contains a main contact point provided with an arc-quenching chamber. In addition, the exemplary installation switching device includes an impact armature system bringing the main contact point into the open position, and a main thermostatic bimetallic strip, which acts on a switching mechanism with a latching point, such that the contact point remains permanently open. The exemplary installation switching device also includes a secondary current path having arranged therein a current-limiting resistor and a selective thermostatic bimetallic strip, which likewise acts on the switching mechanism, and an isolating contact point which is configured to be opened by the switching mechanism. In addition, the exemplary installation switching device includes a handle, with which the main contact point is configured to be opened and closed via the switching mechanism. The secondary current path is connected in parallel with a series circuit including the first bimetallic strip with the main contact point. The main contact point is in the form of a single contact point with a fixed and a movable contact piece. At least a first exhaust air opening for discharging exhaust gases from the arc-quenching device is fitted on a narrow side next to the connection terminal. The exemplary installation switching device also includes a cutout formed on the fastening side and being configured to fasten the installation switching device on a top-hat mounting rail. In addition, the exemplary installation switching device includes a second exhaust air opening fitted on the fastening side and being configured to discharge exhaust gases from the arc-quenching device. The exemplary installation switching device also includes a quick-action fastening apparatus fitted on the fastening side. The quick-action fastening apparatus includes a slide which is configured to bear a movable lug, surrounds the housing on its broad sides, and is configured to be acted on by means of a spring in the direction towards the interior of the cutout.

Therefore, according to an exemplary embodiment of the present disclosure, a cutout for fastening the installation switching device on a top-hat mounting rail is formed on the fastening side, a second exhaust air opening for discharging exhaust gases from the arc-quenching device is fitted on the fastening side, and a quick-action fastening apparatus with a slide which bears a movable lug and which surrounds the housing on its broad sides and is acted on by means of a spring in the direction towards the interior of the cutout, is fitted on the fastening side.

An exemplary beneficial feature of an installation switching device with the configuration according to the present disclosure is that it can be fitted directly on a top-hat mounting rail, wherein an additional exhaust gas path out of the arc-quenching arrangement is opened up by the second exhaust air opening on the fastening side. As a result, in the case of a switching operation at a high current intensity, the switching gases occurring on a large scale in the process can be discharged from the device interior very efficiently and quickly, such that rapid arc quenching is possible even at high current intensities. Furthermore, damaging influences on component parts in the device interior which could occur as a result of deposits of conductive particles from the switching gases which may otherwise be resident in the device interior for a relatively long time, are avoided. As a result of the fact that the slide surrounds the housing on its broad sides, a very secure hold is provided even in the case of heavy devices during fitting of the top-hat rail.

In accordance with an exemplary embodiment of the present disclosure, a third exhaust air opening for discharging exhaust gases from the arc-quenching device is fitted on the narrow side on that side of the connection terminal, which is opposite the first exhaust air opening. Thus, the discharge of switching gases from the housing interior is even more effective and the device is even more suitable for switching high current intensities.

An installation switching device which has the combination of features according to the present disclosure therefore enables a more compact design with small external dimensions and is easy to fit directly on a top-hat mounting rail.

With respect to the further internal design of a switching device according to the present disclosure, reference is made to the above-mentioned DE 10 2008 017 472 A1, the entire disclosure of which is hereby incorporated by reference in its entirety to the basic mode of operation and the internal design in the disclosure content of the present disclosure. Some aspects of the internal design and the mode of operation will be described below.

According to an exemplary embodiment, the main contact point which is in the form of a single contact point has a mechanically simpler design than otherwise known double contact points, and therefore requires low material consumption, effects a low power loss, is compact and thus saves space in the housing for other components.

According to an exemplary embodiment, the movable contact piece of the main contact point is fitted on a main contact lever mounted pivotably in a spatially fixed axis. As a result, the switching accuracy and life of the device is increased since the main contact lever, owing to the fact that it is mounted in a spatially fixed axis, cannot be shifted owing to force impacts acting on it during switching operations and therefore cannot change position relative to the fixed contact piece.

According to an exemplary embodiment, the main thermostatic bimetallic strip is arranged in parallel with the arc guide rail, which is connected to the fixed contact piece of the main contact point. Thus, a very compact internal arrangement of the individual components is possible, as a result of which the entire design becomes very space-saving.

According to an exemplary embodiment, the current-limiting resistor is arranged in a first housing subregion delimited by first partition walls between the outgoing terminal and the arc-quenching chamber. It is thus protected from the effects of the arc and can therefore be positioned very close to the arc-quenching chamber, which saves space in the housing. In addition, it can thus be brought, in the vicinity of the output terminal, up to the edge of the device, which results in very good heat dissipation from the current-limiting resistor element. The current-limiting resistor can therefore have a very compact design overall.

According to an exemplary embodiment, the current-limiting resistor can be in the form of a ceramic resistor block and can be connected, by means of a busbar making contact in sprung fashion with the current-limiting resistor, to the main thermostatic bimetallic strip and, via an electrical conductor with high thermal conductivity, to the selective bimetallic strip. This results in very good heat dissipation from the current-limiting resistor owing to the conduction of heat via the solid conductor connections and by convection with the exterior of the device.

According to an exemplary embodiment, the current-limiting resistor can also include an electrical wire winding with a winding input and a winding output, wherein the winding wire is wound in the manner of a screw around a mount body, which has two opposing end faces connected by a lateral face. At least one holding opening can be introduced in an end face of the mount body, into which holding opening a limb of a heat dissipation element can engage for the purpose of heat dissipation from the wire winding. As a result, when using a wire-winding resistor known in principle and available at very low cost, the heat dissipation out of the current-limiting resistor can be improved further.

According to an exemplary embodiment, the isolating contact point is in the form of a single contact point with a fixed and a movable contact piece and is fitted in a plane which, in the direction perpendicular to the housing broad sides, is behind the plane spanned by the main bimetallic strip and the selective bimetallic strip. As a result, the compact nature of the internal arrangement of the individual components of the installation switching device is increased.

In accordance with such an arrangement, dissipation of the pressure arising in the event of a switching operation and of the switching gases to the outside from the main contact point is ensured and, overall, a very space-saving and more compact arrangement of the assemblies within the housing is ensured. In particular, the isolating contact can be ventilated through the space created by the third housing subregion, for example, the ionized gases produced during opening of the isolating contact can be dissipated through the third housing subregion. They therefore do not linger on the contact pieces or the inner wall faces in the housing. Furthermore, this results in increased dielectric strength overall.

According to an exemplary embodiment, the arc-quenching chamber of the main contact point includes arc splitter plates which are aligned parallel to one another and to the housing broad side and are arranged in at least two groups, wherein the distance of the splitter plates limiting the respective group from the respectively adjacent group or the respectively adjacent partition wall is greater than the distance between the splitter plates within a group. The sum of the distances between adjacent groups of arc splitter stacks and the distances between the arc splitter stacks adjacent to the partition walls and the partition walls themselves in this case corresponds at least to the prescribed minimum air gap. It is possible for two groups of splitter plates with in each case the same number of splitter plates per group to be provided, but three groups of splitter plates with in each case the same number of splitter plates per group is also possible.

If, for example, the arc-quenching chamber is divided into three subregions, each subregion can include approximately six splitter plates. The distance between the central subregion and the adjacent subregions can be 1.5 mm, for example, and the distance between the outer subregions and the partition walls of the arc-quenching chamber can also be approximately 1.5 mm in each case. As a result, the conditions resulting from the relevant specifications in respect of the minimum number of individual splitter plates, the minimum distance between plates, such that this distance counts as an air gap, and the required minimum air gap can also be maintained in the case of a quenching chamber which, owing to the compact housing dimensions, has a limited amount of space available, for example, only less than 30 mm, such as approximately only 28 mm.

According to an exemplary embodiment, the fixed contact piece of the main contact point can be connected to the movable contact piece of the isolating contact point electrically via a detachable plug-type connection. The plug-type connection can be, for example, in the form of a plug-type tulip, into which a plug is inserted. The results in a simplified fitting. In this case, the connection is first isolated; first the assembly of the switching mechanism and the isolating contact point is inserted. The plug-type tulip is fixed in the housing. In the next fitting step, the assembly of the main contact point follows, and the connecting conductor to the main contact is plugged into the plug-type tulip with the plug.

Normally, a plug-type contact is disadvantageous owing to the relatively high contact resistance in comparison with a fixed connection and is therefore not used in installation switching devices of the known generic type, despite the simpler fitting. Nevertheless, in the installation switching device with the configuration according to the present disclosure, the increased contact resistance of a plug-type connection does not represent an obstacle since, owing to the wiring diagram according to the present disclosure, the current loading of the plug-type connection only occurs for a very short period of time. When the current in the secondary circuit is too great, the second bimetallic strip, in interaction with the switching mechanism, interrupts the current flow via the plug-type connection.

According to an exemplary embodiment, the connection between the main thermostatic bimetallic strip and the movable contact piece of the main contact point can be produced via two subconductors, wherein a first subconductor connects the main thermostatic bimetallic strip to the mating arc guide rail opposite the fixed contact point, and a second subconductor connects the mating arc guide rail to the movable contact piece. The subconductors can be, for example, in the form of movable litz wires, with the result that they leave a clearance for movement of the movable contact piece. As a result, an additional blowout loop is provided which drives the arc to quenching on opening of the contact point. Furthermore, the commutating voltage drop which needs to be overcome by the arc during commutation of the movable contact onto the mating guide rail is reduced, as a result of which it commutates more quickly onto the guide rail and arc quenching is thus accelerated.

According to an exemplary embodiment, the connection between the main thermostatic bimetallic strip and the movable contact piece of the main contact point can be implemented via a flexible conductor or a flexible litz wire. This is fastened in punctiform fashion to the movable contact lever of the main contact point, for example, by means of spot welding. A second movable subconductor runs from the fastening point of the first subconductor at the contact lever to the mating arc guide rail which is opposite the fixed contact point. In accordance with an exemplary embodiment, in this case the first and second subconductors are elements of a single litz wire which are fastened, for example spot-welded, to the main thermostatic bimetallic strip and to the arc guide rail and which are fastened, for example likewise spot-welded, to an intermediate fastening point on the movable contact lever. As a result, the commutating voltage drop which needs to be overcome by the arc on commutation from the movable contact to the mating guide rail is reduced, as a result of which the arc commutates more quickly to the guide rail and the arc quenching is thus accelerated.

According to an exemplary embodiment, the housing has approximately the form of an inverted T, and the longitudinal bar of the T is delimited by the front narrow sides and the front front-panel side, and wherein the switching mechanism, the isolating contact and the selective bimetallic strip are arranged in that housing part which is delimited by the front narrow sides and the front front-panel side, whereas the main thermostatic bimetallic strip, the main contact point, the magnet system, the arc-quenching device and the current-limiting resistor are arranged in that housing part which is delimited by the rear narrow sides, the rear front-panel side and the fastening side. An installation switching device with this combination of features in accordance with the present disclosure has a very compact design and makes it possible to use a housing with 1.5 times the standard module width, for example, with a width of 27 mm, in which all of the assemblies and components of an installation switching device of the generic type can be accommodated, wherein the standardized and prescribed air gaps and leakage paths and switching distances are of course maintained. A switching mechanism as described in DE 10 2006 051 807 can be used since this switching mechanism can have such a compact configuration that in any case it fits into the housing part delimited by the front narrow sides and the front front-panel side.

Identical or functionally identical components or assemblies have been denoted by the same reference numerals in the drawings.

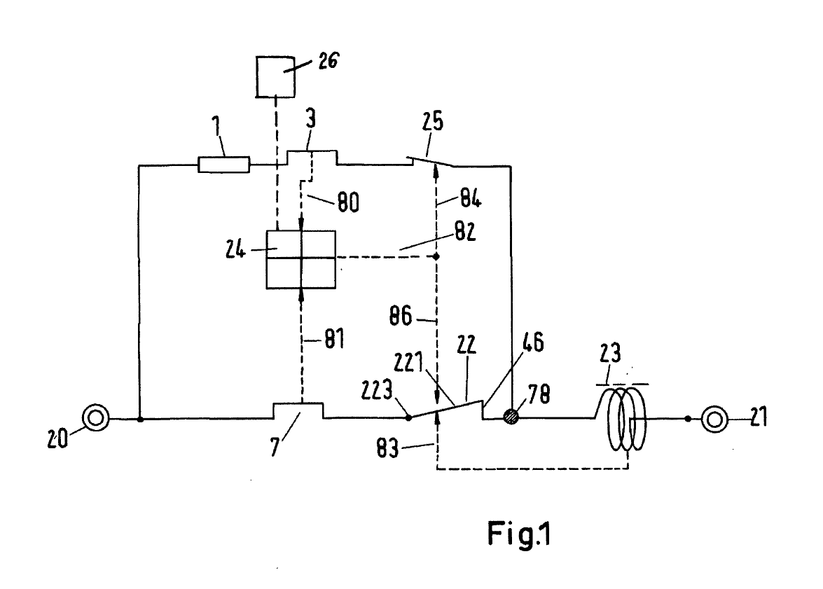

FIG. 1 shows the wiring diagram of an installation switching device according to an exemplary embodiment of the present disclosure. A main current path runs between an input terminal 21 and an output terminal 20 and passes through a main thermostatic bimetallic strip 7, a main contact point 22 and an impact armature system 23. A secondary current path runs in parallel with the series circuit including the main current bimetallic strip 7 and the main contact point 22. The secondary current path includes a current-limiting resistor 1, a selective thermostatic bimetallic strip 3 and an isolating contact point 25.

The main contact point 22 is in the form of a single interrupt. It includes a movable contact lever 221, which bears the movable contact piece 44, and a fixed contact point 222 with a fixed contact piece 46. The movable contact lever 221 is mounted on a spindle 223 fitted fixed in position in the housing.

Furthermore, a mechanical switching mechanism 24 is enclosed in the installation switching device. The switching mechanism is firstly mechanically operatively connected to the main thermostatic bimetallic strip 7 and the selective thermostatic bimetallic strip 3 along the lines of action 81, 80, and secondly the switching mechanism 24 is mechanically operatively connected to the isolating contact point 25 and the main contact point 22 along the lines of action 82, 84, 86.

A handle 26 is mechanically operatively connected to the switching mechanism 24 over a further mechanical operative connection line, illustrated as a dashed line without any reference symbol in FIG. 1. The main current path and the secondary current path can be opened by hand and closed again using the handle 26, and the installation switching device can be switched off and on again manually.

In order to open or switch off the installation switching device, the handle 26 is brought into its open position. In this case, it acts on the switching mechanism 24 via the mechanical operative connection in such a way that the switching mechanism first acts on the main contact point 22 via the operative connection lines 82 and 86 in order to open the main contact point. A short time later, the switching mechanism acts on the isolating contact point 25 via the operative connection lines 82 and 84 in order likewise to open the isolating contact point. During switch-off, the opening of the main contact point therefore leads the opening of the secondary contact point.

For manually closing or switching on the installation switching device, the handle 26 is brought into its closed position. In this case, it acts on the switching mechanism 24 via the mechanical operative connection in such a way that the switching mechanism first acts on the isolating contact point 25 via the operative connection lines 82 and 84 in order to close the isolating contact point. A short time later, the switching mechanism acts on the main contact point 22 via the operative connection lines 82 and 86 in order likewise to close the main contact point. During switch-on, the closing of the isolating contact point therefore leads the closing of the main contact point.

Due to this leading opening and lagging closing of the main contact, during opening of the main contact point in the event of an excess current, the excess current is conducted onto the secondary current path, with the result that the main contact point does not need to open in opposition to the full excess current load. In the secondary current path, the excess current is limited by the current-limiting resistor, with the result that when the isolating contact point finally also opens, the isolating contact point only needs to open in opposition to a relatively low current, with the result that contact damage at the isolating contact point is thus avoidable.

When, during switch-on, first the isolating contact is closed, this has the advantage that, owing to the current-limiting resistor in the secondary current path, first a limited current flow is possible when a load is present before the full current flows on closing of the main contact point. Therefore, connection takes place above a limited connecting current. This protects the contacts even during switch-on. Even when connection to a short circuit takes place, the connecting current is first limited by the current-limiting resistor in the secondary current path, and then the selective bimetallic strip after a certain amount of time ensures renewed disconnection of the limited current. This protects the contacts in this case too.

The further function in the event of a short circuit of the installation switching device according to the present disclosure in accordance with the wiring diagram shown in FIG. 1 is as follows. In the event of the occurrence of a short-circuit current in the main current path, the impact armature system 23 very quickly knocks the movable contact lever 221 away from the fixed contact piece 46 along the line of action 83 and thus opens the main current path at the main contact point 22. During this switching operation, a switching arc is produced at the main contact point 22, and this switching arc is supplied to an arc-quenching arrangement associated with the main contact point 22 and is quenched therein.

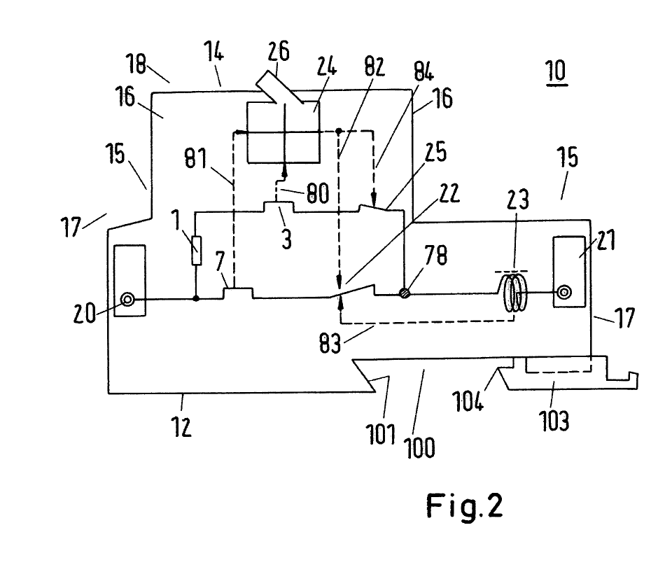

When the main contact point 22 is opened, the current profile commutates onto the secondary current path. The short-circuit current now flows through the current-limiting resistor 1, the selective thermostatic bimetallic strip 3 and the isolating contact point 25 to the node 78, at which the main current path and the secondary current path meet. After a certain delay time, which can be predetermined, inter alia, by the selection of the resistance value of the current-limiting resistor 1, the selective thermostatic bimetallic strip 3 acts along the line of action 80 on the switching mechanism 24 as a result of the limited short-circuit current in the secondary current path in such a way that the switching mechanism opens permanently the isolating contact point 25 along the line of action 82, 84 and the main contact point 22 along the line of action 86. During this switching operation, an arc can likewise be produced which is supplied to a further arc-quenching device associated with the isolating contact point 25 and is quenched therein. Now, both the main contact point and the isolating contact point are interrupted, and the current flow through the device is thus completely interrupted. Renewed switch-on can now take place manually by actuation of the switching mechanism 24 via a handle 26 (see FIG. 2).

FIG. 2 shows the wiring diagram shown in FIG. 1 fitted into the circumferential contour of an installation switching device according to an exemplary embodiment of the present disclosure. In this case, the individual elements of the wiring diagram are illustrated within the housing contour and in a position relative to one another which approximately corresponds to that in a real device.

The installation switching device 10 includes an insulating housing 18, which has a front front-panel side 14, rear front-panel sides 15, a fastening side 12 and front and rear narrow sides 16, 17. The front narrow sides 16 connect the front front-panel side 14 to the rear front-panel sides 15. The rear narrow sides 17 connect the rear front-panel sides 15 to the fastening side 12. The housing 18 thus has approximately the form of an inverted T, wherein the longitudinal bar of the T is limited by the front narrow sides 16 and the front front-panel side 14, and wherein the switching mechanism 24, the isolating contact 25 and the selective bimetallic strip 3 are arranged in the region of this longitudinal bar. The main thermostatic bimetallic strip 7, the main contact point 22, the impact armature system 23, the arc-quenching device 200 and the current-limiting resistor 1 are arranged in the transverse bar of the T-shaped housing which is limited by the rear narrow sides, the rear front-panel side and the fastening side.

An approximately U-shaped cutout 100 is located in the fastening side 12, one lateral limit wall, the left-hand limit wall in the drawing, of the cutout bearing a fixed lug 101. A slide 103 is latched to the fastening side on that wall of the cutout 100 which is opposite the fixed lug 101 and is guided so as to be longitudinally movable and bears a movable lug 104, which points into the interior of the cutout 100. By means of the fixed and movable lugs 101, 104, the device 10 can be snapped onto a top-hat mounting rail in a manner known per se.

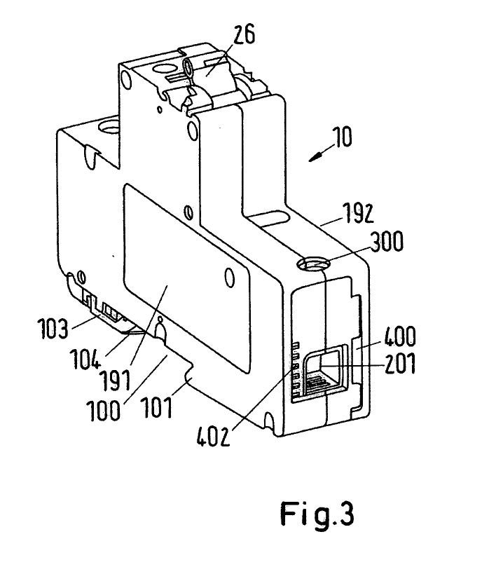

FIG. 3 shows, schematically, a view at an angle of a narrow side of an installation switching device 10 according to an exemplary embodiment of the present disclosure. What is shown is a right-hand broad side 192, a left-hand broad side 191, an opening 201 for inserting a connecting conductor into the output terminal, a screw opening 300 for actuating the clamping screw of the output terminal 20, and exhaust air openings 400, 402 which are connected to the arc-quenching chamber associated with the main contact point in the housing interior. This also has the advantage that the switching gases are discharged quickly at two different points towards the narrow side of the housing and therefore away from the fastening side and the busbar. The switching gases can thus not be deposited on the busbars.

The housing 18 of the installation switching device 10 is constructed from two half-shells, which are assembled and connected to one another at a joint 181. The components and assemblies of the installation switching device 10 according to the present disclosure are arranged one above the other in the interior of the housing 18 partially in a direction perpendicular to the broad sides 191, 192, with the result that a very compact design of the switching device 10 is thus possible. The housing forms approximately the form of an inverted T, the longitudinal web 182 of which is formed by the front narrow sides 16 and the front front-panel side 14, and the transverse web 183 of which is formed by the rear front-panel side 15, the rear narrow sides 17 and the fastening side 12.

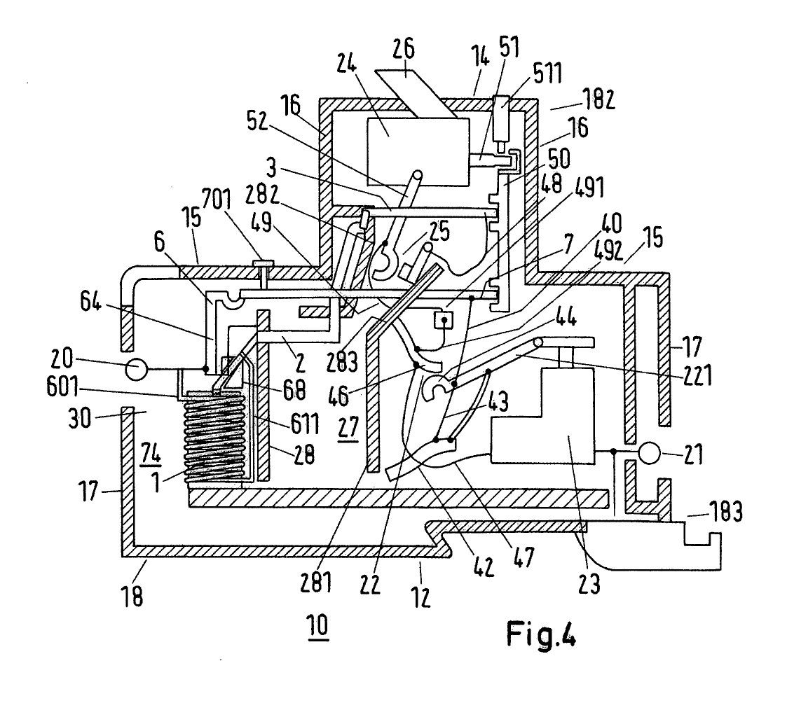

FIG. 4 shows, schematically, a plan view of an open installation switching device with that housing half-shell which forms the right-hand broad side 192 having been removed, according to an exemplary embodiment of the present disclosure.

The output terminal 20 and the input terminal 21 are in this case illustrated schematically as a circle. These may be a screw terminal or a spring-force terminal.

The main current path runs, starting from the terminal 20, via a busbar 6 denoted as second busbar here, a main thermostatic bimetallic strip 7 fitted to the free end of the busbar 6, further from the free end of the main thermostatic bimetallic strip 7 via a litz wire 40 to the movable contact piece 44 of the main contact point 22, from the fixed contact piece 46 of the main contact point 22 via a busbar 47 to the impact armature system 23 and onto the terminal 21. The movable contact piece 44 is connected to an arc guide rail 42 via a litz wire 43.

The litz wires 40 and 42 are sections of a single litz wire which is fastened to the main thermostatic bimetallic strip 7 and the arc guide rail 42. The litz wire is fastened to the movable contact lever 221 in the vicinity of the movable contact piece, for example by means of spot welding, at a central point.

In a further embodiment, a litz wire can also be guided directly from the main thermostatic bimetallic strip 7 to the arc guide rail 42 without being fastened to the movable contact lever 221. A further litz wire is then provided which connects the arc guide rail 42 to the movable contact lever 221.

The main thermostatic bimetallic strip 7 runs approximately parallel to the rear front-panel side 15. It can be calibrated using a calibrating screw 701 form outside the device. The arc guide rail 42 is associated with the arc-quenching device of the main contact point and the latter lies in a plane which is parallel to the left-hand broad side 191 and between the left-hand and right-hand broad sides 191, 192 within the device. Therefore, the arc-quenching arrangement is not illustrated in FIG. 4, with only part of the arc guide rail 42 being shown.

If, owing to a short-circuit current, the impact armature system 23 strikes the main contact point 22 and thus interrupts the main current path, the current flow commutates to the secondary current path. The latter runs, starting from the terminal 20, via an incoming conductor 601 to the current-limiting resistor 1, through the current-limiting resistor 1 via an outgoing conductor 611 and a busbar, referred to as first busbar 2, to the selective thermostatic bimetallic strip 3. The selective thermostatic bimetallic strip 3 is aligned approximately parallel to the rear front-panel side 15. It is accommodated in the longitudinal web 182. The secondary current path then runs from the free end of the selective thermostatic bimetallic strip 3 via a litz wire 48 to the fixed contact piece of the isolating contact point 25, on from the movable contact piece of the isolating contact point 25 via a litz wire 49 to the fixed contact piece 46 of the main contact point 22. There, the secondary current path meets the main current path.

The litz wire 49 leads to a plug-type contact 491. The plug-type contact includes a plug tulip, which is connected, fixed in position, to the housing half-shell. A connecting litz wire 492 is fitted to the fixed contact piece 46 of the main contact point 22 and bears a plug at its free end, which plug is intended for connection to the plug tulip of the plug-type contact 491. During fitting of the device, the connection at the plug-type contact 491 is initially disconnected. First, the assembly comprising the switching mechanism 24 and the isolating contact point 25 with the litz wire 49 and the plug-type tulip is inserted. The plug-type tulip according to the present disclosure is fixed in the housing. In the next fitting step, the assembly of the main contact point 22 in addition with the litz wire 492 and the connecting conductor 492 to the main contact is plugged into the plug-type tulip with the plug. As a result, simple fitting and very good and precise positioning of the individual assemblies within the housing is provided.

In this case, the current-limiting resistor 1 is formed by a heating wire winding 74, which is wound around a mount body with two opposite end faces connected by a lateral face. The heating wire winding 74 surrounds the winding input 601 and the winding output 611 and a turns part. The winding input 601 and the winding output 611 are extension pieces of the turns part, and therefore consist of the same wire. The heat dissipation element 64 is accommodated in a holding opening in the end side of the mount body and is at the same time a mount for the selective thermostatic bimetallic strip 3.

The free end of the heat dissipation element 64 is connected to an outgoing conductor 611. In this way, a resistor assembly which can be manufactured in advance is formed.

Holding projections 68, for example in the form of integrally formed projections which leave a slot free between them are located on the inner side of the housing half-shell. In this slot, the heat dissipation element 64 is clamped firmly, with the result that the resistor assembly is positioned and held firmly in the housing in a simple manner. The heat dissipation element 64 considerably improves the heat dissipation out of the current-limiting resistor 1.

The free end of the selective thermostatic bimetallic strip 3 is coupled to a slide 50, which, when the selective thermostatic bimetallic strip 3 has been bent to a sufficient extent in its thermal tripping direction, for example, in the clockwise direction downwards in the illustration in FIG. 10, actuates the tripping lever 51 of the switching mechanism 24, whereupon the latching point in the switching mechanism 24 is unlatched and the switching mechanism 24 opens the isolating contact point 25 via the secondary contact switching lever 52. By virtue of a further lever mechanism not shown here, the switching mechanism 24 in the process also opens the main contact point 22. Now, the current flow through the device is interrupted completely between the two connection terminals 20, 21. The switching mechanism 24 can also be actuated manually via a handle 26. The general mode of operation of the switching device described here has already been described in the patent application DE 10 2007 020 114, to which express reference is hereby made.

By virtue of a locking device 511, the tripping lever 51 can be fixed in its unlatched position from outside the device, with the result that switch-on from outside by the handle 26 is then no longer possible. The locking apparatus 511 can thus be designed as described in DE 10 2007 018 522.

Overall, therefore, an exemplary and therefore directional transfer of heat out of the current-limiting resistor 1 into the first busbar 2 up to the selective thermostatic bimetallic strip 3 is provided by the configuration according to the present disclosure of the resistor assembly.

This is advantageous because the selective thermostatic bimetallic strip 3 is thus coupled very intensively to the heat dissipated out of the current-limiting resistor 1.

A subregion 27, herein denoted as third subregion, in the housing interior is separated off by partition walls 28, 281, 282 and 283. The two partition walls 282 and 283 are integrally formed with the housing half-shell. They form a type of funnel, whose broad opening is in the region of the isolating contact point 25. When, during opening of the isolating contact point, a switching arc occurs there, gases produced in the process are conducted through this funnel into the third subregion 27. The two partition walls 28 and 281 are in this case part of an intermediate part 500, which is not illustrated for reasons of clarity and which extends substantially parallel to the housing broad side and, as a type of cover, terminates the subregion 27 laterally and at the top. The switching gases of the isolating contact arc are thus guided into the third subregion 27 and cannot be deposited in an uncontrolled manner on the contact points, as a result of which impairment of the contact properties is avoided.

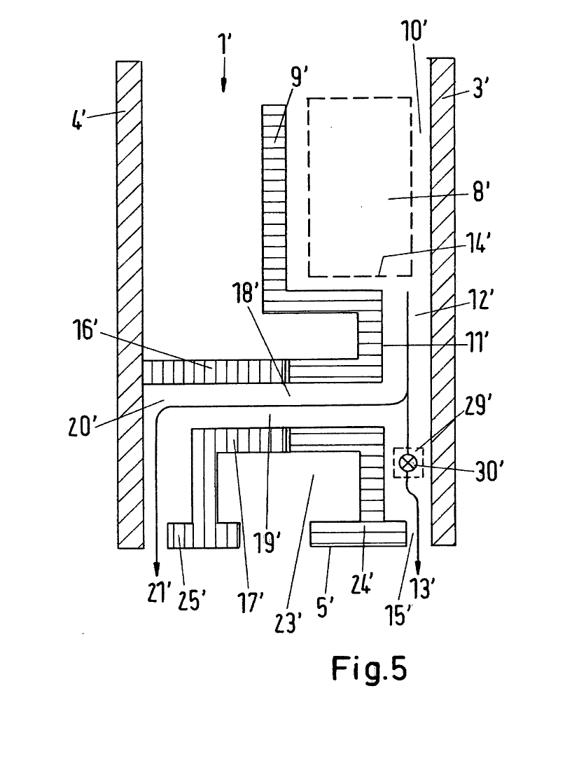

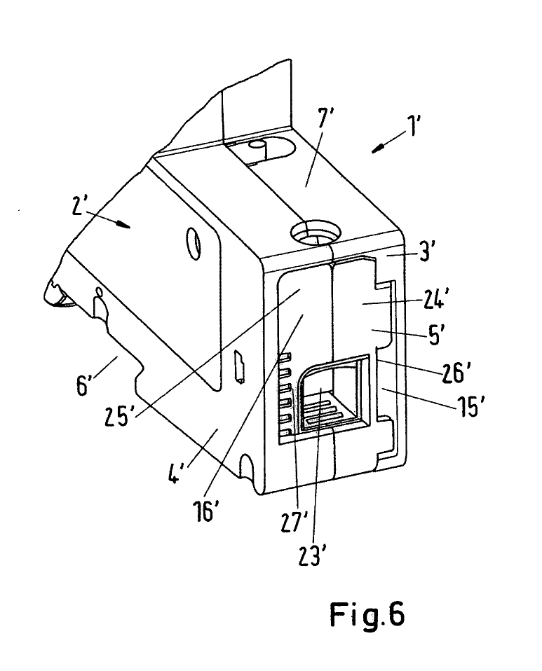

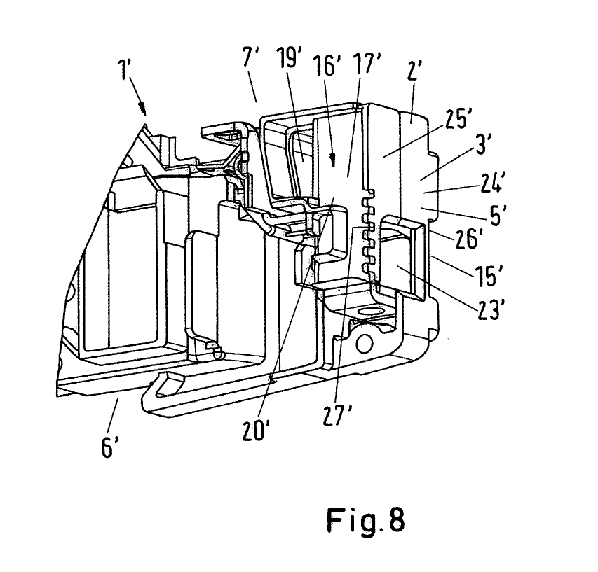

FIG. 5 shows a schematized illustration of a sectional view in the region of the output terminal of an installation switching device 1′, and FIGS. 6 to 8 show perspective partial views of an installation switching device 1′. The installation switching device 1′ has a housing 2′, which includes an upper broad side 3′, a lower broad side 4′, a front-panel side 7′, a fastening side 6′ and a narrow side 5′, and has an arc-quenching device 8′. The arc-quenching device 8′ is an arrangement of arc splitter plates stacked one above the other, as can be seen at the right-hand edge in FIG. 8, and as is known in principle.

An intermediate piece 9′ is arranged in the housing 2′ in such a way that the arc-quenching device 8′ is accommodated in a subarea 10′ between the upper broad side 3′ and the intermediate piece 9′. An exhaust air wall 11′ running parallel to the broad sides 3′, 4′ forms, with the upper broad side 3′, a first exhaust air channel 12′, which conducts the exhaust gas flow 13′ out of that end 14′ of the arc-quenching device 8′ which points towards the narrow side 5′ towards a first exhaust air opening 15′ in the narrow side wall 5′ of the housing 2′.

A terminal insulating part 16′ is arranged on the narrow side 5′ between the exhaust air wall 11′ of the intermediate piece 9′ and the lower broad side 4′. The terminal insulating part has a terminal area partition wall 17′, and an intermediate opening 18′ is provided in the exhaust air wall 11′ of the intermediate piece 9′, the intermediate opening being aligned with an insulating part opening 19′ in the terminal insulating part 16′. As a result, a second exhaust air channel 20′ is formed which guides a first partial flow 21′ of the exhaust gases from the intermediate opening 18′ between the terminal area partition wall 17′ and the lower broad side 4′ to a second exhaust air opening 22′ in the narrow side wall 5′.

The terminal area partition wall 17′ of the terminal insulating part 16′ and the exhaust air wall 11′ of the intermediate piece 9′ form, in the region of the narrow side wall 5′, a terminal area 23′ which is open towards the narrow side 5′ for accommodating a connection terminal. In this case, the narrow side wall 5′ is formed partially by a first and second plate 24′, 25′, which are integrally formed on the intermediate piece 9′ and the terminal insulating part 16′.

The first plate 24′ has a recess 26′ in its narrow side 5′ pointing towards the upper broad side 3′. When the upper broad side 3′ of the housing has been positioned, an elongate slot is thus produced between the upper broad side 3′ and the first plate, and this slot forms the first exhaust air opening 15′. This is therefore formed in the region of the recess 26′ between the first plate 24′ and the upper broad side 3′ of the housing 2′.

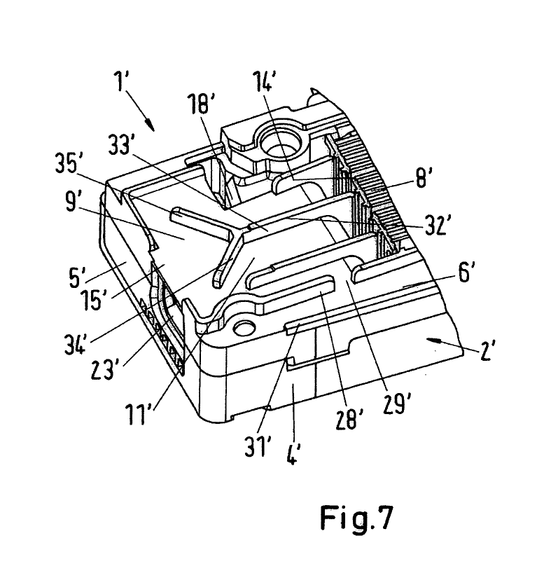

The second plate 25′ also has at least one recess 27′ in its narrow side 5′ pointing towards the lower broad side 4′, with the result that the second exhaust air opening 22′ is formed in the region of the recess 27′ between the second plate 5′ and the rear broad side 4′ of the housing 2′. As can be seen in FIG. 7, the second recess is in this case realized by a comb-like structure, with the result that the second exhaust air opening 22′ is a series of relatively small individual holes arranged one above the other.

A web 28′ limiting the first exhaust air channel 12′ towards the fastening side 6′ is integrally formed on the exhaust air wall 11′ (see FIG. 8). This web 28′ guides the exhaust gases out of the arc-quenching device parallel to the fastening side towards the first and second exhaust air openings 15′, 22′. A web opening 29′ is fitted just after the end 14′ of the arc-quenching device 8′, the web opening opening the web 28′ in the direction towards the fastening side 6′. As a result, the second partial flow 30′ of exhaust gases can be conducted through the web opening 29′ to the fastening side 6′ and there through a third exhaust air opening 31′ to the outside. The third exhaust air opening 31′ is produced as a result of a furrow-like cutout in that edge of the intermediate piece 9′ which points towards the fastening side 6′. The upper broad side 3′ of the housing 2′ has a cutout at this point.

If the upper broad side 3′ of the housing 2′ is positioned onto the intermediate piece 9′, the third exhaust air opening 31′ is then produced at this point.

Guide webs 32′ are fitted to the exhaust air wall 11′ of the intermediate piece 9′ and divide the exhaust gases emerging from the arc-quenching device 8′ into the exhaust gas flow 13′ and the first and second partial flows 21′, 30′. A first central web 33′ divides the exhaust gas flow into an upper and lower partial flow. The first web bears a Y-like branch with two Y limbs 34′, 35′ at its free end. As a result, the upper partial flow is deflected upward in the direction towards the front-panel side and some of the upper partial flow is supplied to the intermediate opening 18′. Another proportion of the upper partial flow flows around the Y limb 35′ and arrives at the first exhaust air opening 15′.

Correspondingly, a first proportion of the lower partial flow is deflected downwards in the direction towards the fastening side 6′ by the lower Y limb 34′, where it is supplied to the third exhaust air opening 31′. A second proportion of the lower partial flow flows around the lower Y limb 34′ and likewise arrives at the first exhaust air opening 15′.

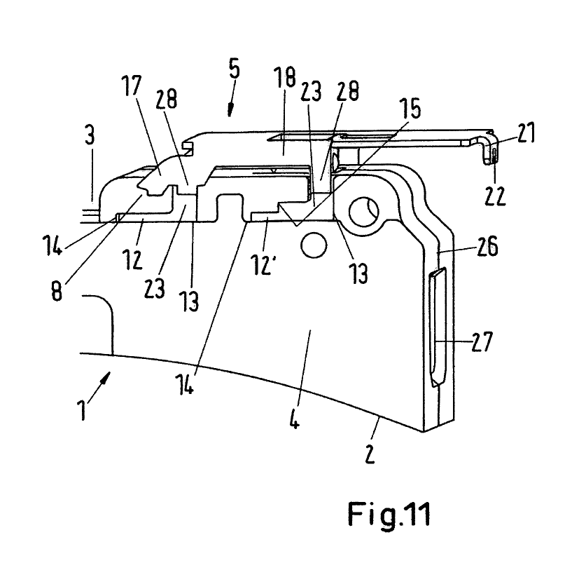

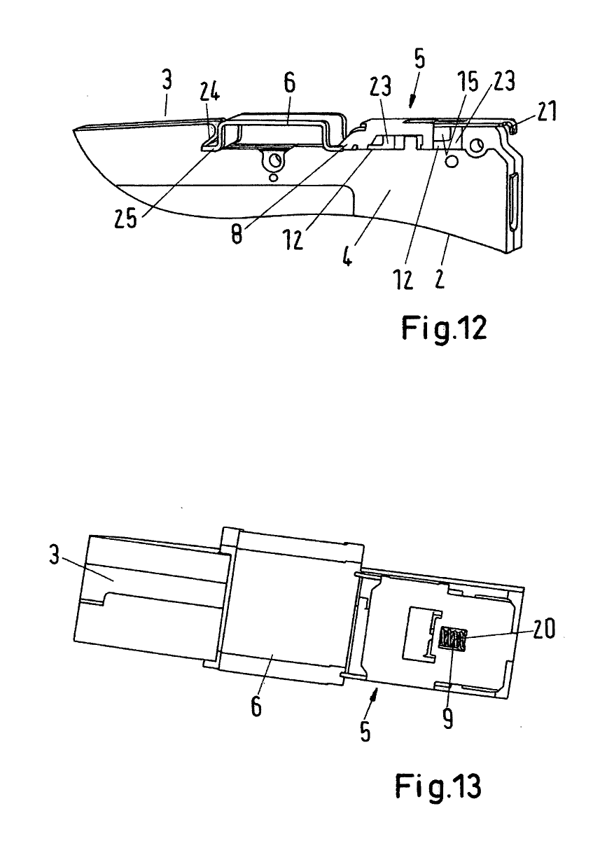

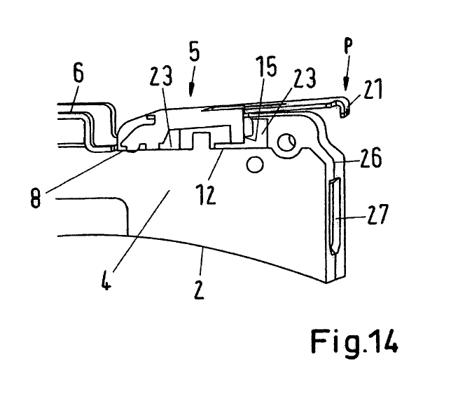

FIG. 11 and FIG. 12 show part of an electrical installation switching device 1″ with a housing 2″, which includes a fastening side 3″ and broad sides 4″, and with a quick-action fastening apparatus 5″ for snapping the installation switching device 1″ onto a top-hat mounting rail 6″. The drawing shows a partial view of the fastening side 3″. Shown is the fixed lug 24″, with which the installation switching device 1″ is suspended on one of the longitudinal strips 25″ of the top-hat mounting rail during fastening on the top-hat mounting rail 6″. Furthermore, the fastening apparatus for fastening the installation switching device 1″ on the top-hat mounting rail 6″ includes a slide 7″, which bears a stop lug 8″, wherein the slide 7″ can be pushed in the direction of the top-hat mounting rail 6″ by means of a spring 9″, with the result that the stop lug 8″ forms the movable lug of the quick-action fastening apparatus 5″.

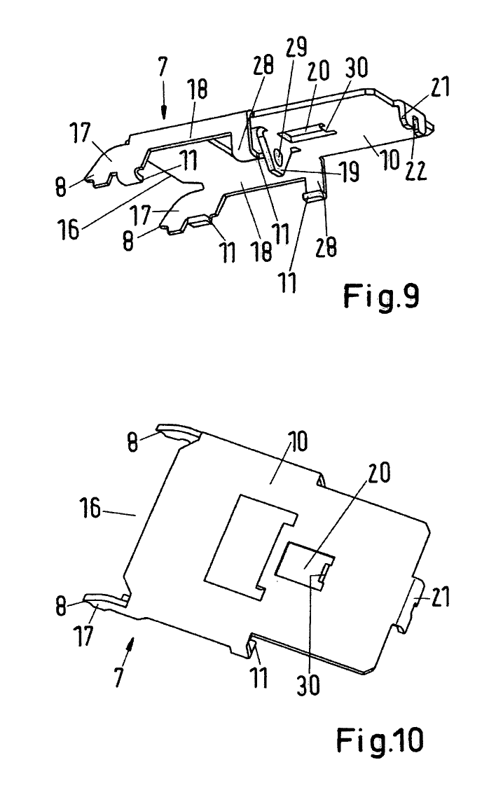

FIGS. 9 and 10 show the slide 7″. The slide 7″ includes a base plate 10″ and bears lateral peripheral strips 11″ at the longitudinal sides thereof. For this purpose, a guide tab 18″ is integrally formed on each of the longitudinal sides of the slide 7″ perpendicular to the base plate 10″, which guide tab bears the peripheral strip 11″. In this case, the peripheral strips 11″ are fitted to the free end of in each case one guide arm. As a result of the peripheral strips, the slide 7″ is to a certain extent provided with a U-shaped cross-sectional contour, with which it surrounds the housing of the installation switching device 1″ on the outside. The peripheral strips are bent inwards and thus cause the slide to be held in the guide grooves.

The slide 7″ shown in FIG. 9 and FIG. 10 has in total four peripheral strips, two at the front and two at the rear. Correspondingly, the housing 2″ has four guide grooves 12″, 12″′ on its broad sides 4″, close to the fastening sides, with in each case one front guide groove 12″ being arranged on a broad side in the vicinity of that cutout in the fastening side which accommodates the top-hat mounting rail and one rear guide groove 12″′ being arranged close to the narrow side 26″ of the housing 2″. The terminal access opening 27″ is also located in the narrow side 26″ of the housing 2″; see FIG. 11.

The slide 7″ is held longitudinally displaceably in the guide grooves 12″, 12″′ in the housing broad side 4″. Each of the guide grooves 12″, 12″′ runs between a withdrawal and a fixing end 13″, 14″. The rear guide groove 12″′ has a latching contour 15″, which is arranged between the withdrawal and the fixing end 13″, 14″, with the result that the peripheral strips 11″ engage in the latching contour 15″ in a central position between the withdrawal and the fixing end 13″, 14″ and can thus hold the slide 7″ in a withdrawal position, in which the stop lug 8″ releases the top-hat mounting rail 6″. The latching contour 15″ is in the form of a step-like widened portion of the guide groove 12″ extending in the direction of the fastening side 3″.

FIG. 14 shows this state. In this case, the slide 7″ is located in the disassembly position.

An actuating tab 21″ with an engagement opening 22″ for an actuating tool is located on the narrow side of the slide 7″ which is opposite the stop lug 8″.

The slide 7″ has been brought into the disassembly position shown in FIG. 14 starting from the fitting position shown in FIG. 12 by virtue of a tool, for example a screwdriver, being used to engage in the engagement opening 22″ in the actuating tab 21″, the slide 7″ having been positioned at an angle at its actuating end by pivoting in the counterclockwise direction and having been withdrawn upwards and rearwards until the peripheral strip 11″ has latched in the latching contour 15″. As a result of the latching in the latching contour 15″, the slide is held in the disassembly position counter to the restoring force of the spring 9″. The device can now be removed from the top-hat mounting rail. In particular multi-pole devices which have been assembled by arranging a plurality of single-pole devices next to one another in a row, can thus be removed more easily. The reason for this is as follows: when a plurality of, for example three, single-pole devices are assembled next to one another to form a three-pole device, each of the three single-pole devices brings a slide 7″ with it. The three-pole device is then held with in total three slides on the top-hat mounting rail. In order to remove the device from the top-hat mounting rail, three slides need to be brought into their disassembly position and held there. Without a latching contour 15″ which holds each of the slides firmly in the disassembly position, it would be very difficult to do this since in this case the fitter would have to hold three slides by hand simultaneously in the disassembly position until the device has been removed.

In order to bring the slide back into the fitting position, a slight pressure in arrow direction P (FIG. 14) on the free end is sufficient, and the peripheral strip slides out of the latching contour, with the result that the spring 9″ can press the slide 7″ back into its fitting position.

The slide 7″ bears two stop tabs 17″ running parallel to the longitudinal side of the base plate 10″ on its stop-side narrow side 16″, each stop tab 17″ having a stop lug 8″. There are thus two stop lugs which are positioned apart from one another by the width of the slide 7″. Thus, the device is held securely and is largely protected from being twisted in the state in which it is latched onto the top-hat rail.

On the longitudinal sides of the slide 7″, the slide bears, perpendicular to the base plate 10″, a guide tab 18″, which bears the peripheral strip 11″. The peripheral strip 11″ is in this case integrally formed on the free end of a holding arm 28″, which in turn extends out of the guide tab 18″ downwards perpendicularly from the base plate 10″; see FIG. 9. The slide 7″ is in this case a stamped and bent part from sheet steel, and the guide tabs, the holding arm 28″ and the peripheral strip 11″ are produced from one piece of sheet steel by stamping and bending.

A holding tab 19″ is integrally formed on the base plate 10″ and acts as stop face for the spring 9″. The holding tab 19″ bears a depression 29″, which acts as fixing point for the spring 9″ acting there.

Furthermore, a fitting opening 20″ for inserting the spring 9″ is located in the base plate 10″. A lug 30″ on that end of the fitting opening 20″ which is opposite the holding tab 19″ facilitates fitting of the spring. The spring 9″ is a cylindrical spring.

The guide groove 12″ is connected to a fitting groove 23″, wherein the fitting groove 23″ points perpendicularly out of the guide groove 12″ in the direction towards the fastening side 3″ and is open on the fastening side 3″ for insertion of the peripheral strip 11″. FIG. 11 shows how the slide 7″ is inserted into the fitting grooves 23″ from the fastening side 3″ with its peripheral strips on the holding arms 28″ in order to be fitted on the housing 2″ and is pressed against the fastening side 3″ until it rests in the guide groove 12″. As a result of being subsequently shifted in the guide grooves towards the top-hat mounting rail, the slide 7″ is brought into its holding position or fitted position. In this case, when the slide 7″ is first positioned on the housing 2″, the spring 9″ is also inserted through the fitting opening 20″.

The present disclosure also includes, in addition to the described exemplary embodiments, any desired combinations of preferred embodiments and individual configuration features or developments insofar as they are not mutually exclusive.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Current-limiting resistor
2 First busbar
3 Selective thermostatic bimetallic strip
6 Second busbar
7 Main thermostatic bimetallic strip
8 Compression spring of connection terminal, spring terminal
10 Selective circuit breaker, installation switching device
12 Fastening side
14 Front front-panel side
15 Rear front-panel side
16 Front narrow side
17 Rear narrow side
18 Housing
20 Output terminal
21 Input terminal, access terminal
22 Main contact point
23 Impact armature system
24 Switching mechanism
25 Isolating contact point
26 Handle
28 First partition wall
40 Litz wire
42 Arc guide rail
43 Litz wire
44 Movable contact piece
46 Fixed contact piece
47 Busbar
48 Litz wire
49 Litz wire
50 Slide
51 Tripping lever
52 Secondary contact switching lever
64 Heat dissipation element
68 Holding apparatus
74 Heating wire winding
78 Node
80 Line of action
81 Line of action
82 Line of action
83 Line of action
84 Line of action
86 Line of action
100 U-shaped cutout
101 Fixed lug
103 Slide
104 Movable lug
182 Longitudinal web
191 Left-hand broad side
192 Right-hand broad side
201 Opening in output terminal
221 Movable contact lever
222 Fixed contact point
223 Spatially fixed spindle
281 Partition wall
282 Partition wall
283 Partition wall
300 Screw opening
301 Spatially fixed spindle
400 Exhaust air opening
401 Web
402 Exhaust air opening
431 Fixed contact guide rail
491 Plug-type contact
492 Connecting litz wire
500 Intermediate part
511 Locking device
601 Winding input
611 Winding output
701 Calibrating screw
1′ Installation switching device
2′ Housing
3′ Upper broad side
4′ Lower broad side
5′ Narrow side
6′ Fastening side
7′ Front-panel side
8′ Arc-quenching device
9′ Intermediate piece
10′ Subarea
11′ Exhaust air wall
12′ First exhaust air channel
13′ Exhaust gas flow
14′ End of arc-quenching device
15′ First exhaust air opening
16′ Terminal insulating part
17′ Terminal area partition wall
18′ Intermediate opening
19′ Insulating part opening
20′ Second exhaust air channel
21′ First partial flow
22′ Second exhaust air opening
23′ Terminal area
24′ First plate
25′ Second plate
26′ Recess
27′ Recess
28′ Web
29′ Web opening
30′ Second partial flow
31′ Third exhaust air opening
32′ Guide web
33′ Central web
34′ Y Limb
35′ Y Limb
1″ Electrical installation switching device
2″ Housing
3″ Fastening side
4″ Broad side
5″ Quick-action fastening apparatus
6″ Top-hat mounting rail
7″ Slide
8″ Stop lug
9″ Spring
10″ Base plate
11″ Peripheral strip
12″, 12′″ Guide groove
13″ Withdrawal end
14″ Fixing end
15″ Latching contour
16″ Stop-side narrow side
17″ Stop tab
18″ Guide tab
19″ Holding tab
20″ Fitting opening
21″ Actuating tab
22″ Engagement opening
23″ Fitting groove
24″ Fixed lug
25″ Longitudinal strip
26″ Narrow side
27″ Terminal access opening
28″ Holding arm
29″ Depression
30″ Lug

What is claimed is:

1. An installation switching device comprising:
a housing including a fastening side, a front and a rear front-panel side, broad sides and front and rear narrow sides connecting the fastening side and the front-panel side;
a main current path, which runs between an input terminal and an output terminal and contains a main contact point provided with an arc-quenching chamber;
an impact armature system bringing the main contact point into the open position;
a main thermostatic bimetallic strip, which acts on a switching mechanism with a latching point, such that the contact point remains permanently open;
a secondary current path having arranged therein a current-limiting resistor and a selective thermostatic bimetallic strip, which likewise acts on the switching mechanism, and an isolating contact point which is configured to be opened by the switching mechanism;
a handle, with which the main contact point is configured to be opened and closed via the switching mechanism, wherein:
the secondary current path is connected in parallel with a series circuit including the first bimetallic strip with the main contact point;
the main contact point is in the form of a single contact point with a fixed and a movable contact piece;
at least a first exhaust air opening for discharging exhaust gases from the arc-quenching device is fitted on a narrow side next to the connection terminal; and
the installation switching device comprises:
a cutout formed on the fastening side and being configured to fasten the installation switching device on a top-hat mounting rail;
a second exhaust air opening fitted on the fastening side and being configured to discharge exhaust gases from the arc-quenching device; and
a quick-action fastening apparatus fitted on the fastening side, the quick-action fastening apparatus including a slide which is configured to bear a movable lug, surrounding the housing on its broad sides, and being configured to be acted on by means of a spring in the direction towards the interior of the cutout.

2. The installation switching device as claimed in claim 1, comprising:
a third exhaust air opening for discharging exhaust gases from the arc-quenching device, the third exhaust air opening being fitted on the narrow side on the side of the connection terminal which is opposite the first exhaust air opening.

3. The installation switching device as claimed in claim 1, wherein the main thermostatic bimetallic strip is arranged approximately in parallel with the arc guide rail, which is connected to the fixed contact piece of the main contact point.

4. The installation switching device as claimed in claim 1, wherein the isolating contact point is in the form of a single contact point with a fixed and a movable contact piece and is fitted in a plane which, in the direction perpendicular to the housing broad sides, is behind a plane spanned by the main bimetallic strip and the selective bimetallic strip.

5. The installation switching device as claimed in claim 1, wherein the impact armature system is arranged between the input terminal and the phase connection rail, and
wherein a first coil end of the magnet coil of the impact armature system is connected to the input terminal, and a second coil end of the magnet coil is connected to the fixed contact piece of the main contact point.

6. The installation switching device as claimed in claim 1, wherein the housing has approximately the form of an inverted T, and a longitudinal bar of the T is delimited by the front narrow sides and the front front-panel side,
wherein the switching mechanism, the isolating contact and the selective bimetallic strip are arranged in a housing part which is delimited by the front narrow sides and the front front-panel side, and
wherein the main thermostatic bimetallic strip, the main contact point, the magnet system, the arc-quenching device and the current-limiting resistor are arranged in a housing part which is delimited by the rear narrow sides, the rear front-panel side and the fastening side.

7. The installation switching device of claim 1, wherein the installation switching device is a selective circuit breaker.

8. The installation switching device as claimed in claim 2, wherein the main thermostatic bimetallic strip is arranged approximately in parallel with the arc guide rail, which is connected to the fixed contact piece of the main contact point.

9. The installation switching device as claimed in claim 8, wherein the isolating contact point is in the form of a single contact point with a fixed and a movable contact piece and is fitted in a plane which, in the direction perpendicular to the housing broad sides, is behind a plane spanned by the main bimetallic strip and the selective bimetallic strip.

10. The installation switching device as claimed in claim 9, wherein the impact armature system is arranged between the input terminal and the phase connection rail, and
wherein a first coil end of the magnet coil of the impact armature system is connected to the input terminal, and a second coil end of the magnet coil is connected to the fixed contact piece of the main contact point.

11. The installation switching device as claimed in claim 10, wherein the housing has approximately the form of an inverted T, and a longitudinal bar of the T is delimited by the front narrow sides and the front front-panel side,
wherein the switching mechanism, the isolating contact and the selective bimetallic strip are arranged in a housing part which is delimited by the front narrow sides and the front front-panel side, and
wherein the main thermostatic bimetallic strip, the main contact point, the magnet system, the arc-quenching device and the current-limiting resistor are arranged in a housing part which is delimited by the rear narrow sides, the rear front-panel side and the fastening side.
